(19) United States
(12) Patent Application Publication
(10) Pub. No.: US 2025/0148525 A1
(43) Pub. Date: May 8, 2025

(54) INFORMATION PROCESSING TERMINAL AND INFORMATION PROCESSING METHOD

(71) Applicant: Toshiba Tec Kabushiki Kaisha, Tokyo (JP)

(72) Inventors: Fumio NAKATSUKASA, Yokohama Kanagawa (JP); Yuna OTANI, Ota Tokyo (JP); Tomonori SUGIYAMA, Yokohama Kanagawa (JP); Kouki OKANO, Yokohama Kanagawa (JP); Kazumi FUJIMURA, Koto Tokyo (JP); Yoshiki KURIBAYASHI, Toride Ibaraki (JP)

(21) Appl. No.: 18/771,868

(22) Filed: Jul. 12, 2024

(30) Foreign Application Priority Data
Nov. 6, 2023 (JP) 2023-189175

(51) Int. Cl. G06Q 30/0601; G06Q 20/20

(52) U.S. Cl. CPC G06Q 30/0633; G06Q 20/208; G06Q 30/0641

(57) ABSTRACT

According to an embodiment, a cart-based point-of-sale terminal includes a display device mounted on a shopping cart and a control unit. The control unit is configured to register items of merchandise for purchase in a sales transaction and cause the display device to display a shopping basket notification to a user before a user can register an item of merchandise. The shopping basket notification may be a screen, window, or the like requesting that the user confirm a shopping basket has been placed on the shopping cart.

### CROSS-REFERENCE TO RELATED APPLICATION

This application is based upon and claims the benefit of priority from Japanese Patent Application No. 2023-189175, filed Nov. 6, 2023, the entire contents of which are incorporated herein by reference.

### FIELD

Embodiments described herein relate generally to an information processing terminal and an information processing method.

### BACKGROUND

A cart-based point-of-sale (POS) system is coming into widespread use. A cart-based POS system, a shopping cart is equipped with a POS device. In such a POS system, the customer performs merchandise registration by himself or herself and then places the registered merchandise in the shopping cart.

If the shopping cart is equipped with a sensor that detects a change in weight, an error indication may be given when a merchandise item put in the shopping cart without registration or if there is a failure to return a merchandise item to the shelf when a registration is cancelled. The placement or removal of items from the shopping cart may be detected based on a change in weight detected by the sensor on the shopping cart.

In some cases, when shopping carts and shopping baskets are arranged at a distance from each other in the store, a customer may start shopping with the basket then eventually place the basket into or on to the shopping cart and the weighing of items in the shopping cart may be thrown off. In such a case, the POS system may detect an increase in weight matching the basket via the sensor or the like, and determine, in error, that a merchandise item was put in the shopping cart without merchandise registration and give an error indication (notice) of a failure to scan the item before placing in the cart or the like.

In view of this problem in the art, a technique that can avoid an error indication for failures to scan or the like due to the detection of the weight of a basket placed on the cart is demanded.

### BRIEF DESCRIPTION OF THE DRAWINGS

FIG. 1 is a block diagram illustrating an information processing system according to an embodiment.

FIG. 2 is a sequence chart illustrating procedures of information processing in an information processing system.

FIG. 3 is a schematic view showing an example of a shopping start image displayed at a POS terminal.

FIG. 4 is a schematic view showing an example of a notification image displayed at a POS terminal.

FIG. 5 is a schematic view showing an example of a notification image.

FIG. 6 is a schematic view showing an example of a notification image.

FIG. 7 is a schematic view showing an example of a notification image.

FIG. 8 is a schematic view showing an example of a notification image.

FIG. 9 is a flowchart illustrating a first mode of information processing.

FIG. 10 is a flowchart illustrating a second mode of information processing.

FIG. 11 is a flowchart illustrating a third mode of information processing.

FIG. 12 is a flowchart illustrating a fourth mode of information processing.

FIG. 13 is a flowchart illustrating a fifth mode of information processing.

FIG. 14 is a flowchart illustrating a first mode of information processing for a warning notification.

FIG. 15 is a flowchart illustrating a second mode of information processing for a warning notification.

FIG. 16 is a flowchart illustrating a third mode of information processing for a warning notification.

FIG. 17 is a flowchart illustrating a fourth mode of information processing for a warning notification.

### DETAILED DESCRIPTION

Certain example embodiments described herein provide improved information processing terminals and methods for cart-based point-of-sale systems and the like that can reduce the number of error notifications users, system attendants, and the like receive during operations.

In general, according to one embodiment, a cart-based point-of-sale terminal includes a display device mounted on a shopping cart and a control unit. The control unit is configured to register items of merchandise for purchase in a sales transaction, and cause the display device to display a shopping basket notification to a user before a user can register an item of merchandise. The shopping basket notification may be a screen, window, or the like requesting that the user confirm or check whether a shopping basket has been placed on the shopping cart.

### Example of Configuration of an Embodiment

An example embodiment will now be described using the drawings. The components, elements, aspects that are the same or substantially the same in different drawings are denoted by the same reference symbols and repeated description may be omitted.

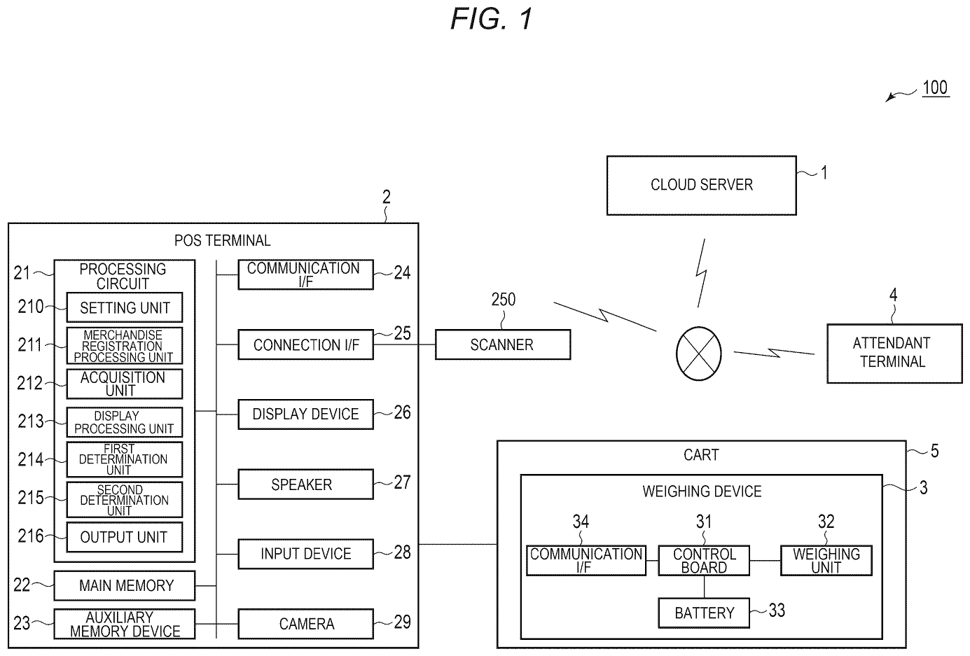

FIG. 1 is a block diagram illustrating an information processing system 100 according to an embodiment.

The information processing system 100 includes a cloud server 1, a POS terminal 2, an attendant terminal 4, and a cart 5. The cart 5 includes a weighing device 3. The cloud server 1, the POS terminal 2, and the attendant terminal 4 are connected communicably with each other via a network. For example, the network can be one or more networks such as the internet, a mobile communication network, and a LAN (local area network). The networks may be a wireless network or may include a wired network. The information processing system 100 may be a system including any two of the cloud server 1, the POS terminal 2, and the attendant terminal 4.

The cloud server 1 collects data and processes the collected data. The cloud server 1 is connected communicably with the POS terminal 2 and the attendant terminal 4 via the network. The cloud server 1 receives various data from the POS terminal 2 and the attendant terminal 4 and outputs various data to the POS terminal 2 and the attendant terminal 4.

The POS terminal 2 can communicate with another electronic device. The POS terminal 2 is, for example, a device used by a customer who shops at a store to register merchandise. The POS terminal 2 is a device that can perform a merchandise registration operation such as registration of a merchandise item to be purchased, change in the number of items, and cancellation. The customer registers a merchandise item to be purchased, for example, by using a camera or a scanner that is built in the POS terminal 2 or externally connected, to read the identification code or the like of the merchandise item. The customer, for example, operates the POS terminal 2 to perform an operation such as the cancellation of a registered merchandise item or change in the number of items. The POS terminal 2 may be a terminal installed and used on the cart 5 or may be a terminal used without being installed on the cart 5. The POS terminal 2 may be a terminal lent at the store or may be a terminal owned by a user. The POS terminal 2 can be a PC (personal computer), a smartphone, or a tablet terminal or the like. The customer may also be referred to as a user or a person. The POS terminal 2 is an example of an information processing terminal. In the description below, the customer may be referred to as the user of the POS terminal 2 or simply as the user. A plurality of POS terminals 2 may be provided at a store.

The weighing device 3 can communication with another electronic device installed on the cart 5. The weighing device 3 detects the weight in the cart 5. The weighing device 3 sets a zero value (tare value) at a weighing unit 32 when the user starts shopping using the cart 5. The weighing device 3 sets the zero value so that the initial weight detected by the weighing unit 32 is considered to be zero when a shopping basket is placed on the cart 5. For example, a notification image (for example, FIGS. 4 to 6) displayed at the POS terminal 2 so that the weight detected by the weighing unit 32 can be set to the zero value after a shopping basket has been placed on the cart 5. The cart 5 is, for example, a shopping cart used by the user while shopping at the store. It is assumed here that one shopping basket can be placed an upper tier and another on a lower tier, that is, two shopping baskets in total, can be placed on the cart 5. A shopping basket may be placed on both or just one of the upper tier and the lower tier of the cart 5. The weighing device 3 can detect the weight on the upper tier and the lower tier of the cart 5. The weighing device 3 may be a device that can detect the total of the weight on the upper tier and the weight on the lower tier of the cart 5 or may be a device that can separately detect the weight on the upper tier and the weight on the lower tier. Of course, the total number of shopping baskets that can be placed on the cart 5 is not limited to two. The cart 5 is one example of a cart configured to be able to detect a weight of items placed thereon. The shopping basket can also be referred to simply as a basket.

The attendant terminal 4 can communicate with another electronic device. The attendant terminal 4 is, for example, a device used by an attendant (store clerk) who monitors actions of the user and supports the user while at the store. For example, the attendant terminal 4 is a PC, a smartphone, or a tablet terminal or the like. The attendant may also be referred to as a store staff, a clerk, a user, an operator, or a person. The attendant is an example of the user of the attendant terminal 4. A plurality of attendant terminals 4 may be provided at a store.

An example of the configuration of a POS terminal 2 will now be described.

The POS terminal 2 includes a processing circuit 21, a main memory 22, an auxiliary memory device 23, a communication interface 24, a connection interface 25, a display device 26, a speaker 27, an input device 28, and a camera 29. The elements forming the POS terminal 2 are connected in such a way as to be able to input and output a signal from and to each other.

The processing circuit 21 can be an element forming a computer in the POS terminal 2. The processing circuit 21 includes one or more circuits that execute a plurality of processes by a plurality of functions. For example, the circuit is a processor, an ASIC (application-specific integrated circuit) or an FPGA (field-programmable gate array) but is not limited to these. For example, the processor is a CPU (central processing unit) or a GPU (graphics processing unit) but is not limited to these. The processing circuit 21 loads a program from the main memory 22 or the auxiliary memory device 23, into the main memory 22. The program provides instructions and algorithms for the processing circuit 21 to execute processing corresponding to the functions described for an embodiment. The processing circuit 21 executes the program loaded in the main memory 22 and thus can execute various processing according to an embodiment.

The main memory 22 includes a non-volatile memory area and a volatile memory area. The main memory 22 stores an operating system or a program in the non-volatile memory area. The main memory 22 uses the volatile memory area as a work area where data can be rewritten by the processing circuit 21 according to need. For example, the main memory 22 includes a ROM (read-only memory) as the non-volatile memory area. For example, the main memory 22 includes a RAM (random-access memory) as the volatile memory area. The main memory 22 is an example of a memory unit of the POS terminal 2.

The auxiliary memory device 23 is equivalent to an auxiliary memory part of the POS terminal 2. The auxiliary memory device 23 includes one or more memory devices. The memory device is an EEPROM® (electrically erasable programmable read-only memory), an HDD (hard disk drive), an SSD (solid-state drive), or a flash memory or the like, but is not limited to these. The auxiliary memory device 23 stores the foregoing program, and data used by the processing circuit 21 to execute various processing and data generated by the processing by the processing circuit 21.

The auxiliary memory device 23 stores transaction information of the POS terminal 2. The transaction information includes identification information or the like of the POS terminal 2. The identification information of the POS terminal 2 is unique identification information allocated on a per POS terminal 2 basis in order to identify each POS terminal 2. The identification information of the POS terminal 2 includes the IP address or the like of the POS terminal 2. The transaction information may also include user identification information of the user of the POS terminal 2. The user identification information is unique identification information allocated on a per user basis in order to identify each user.

The transaction information includes a store code, a terminal code, a transaction code, a transaction status, and transaction details information. The transaction code is unique identification information allocated on a per transaction basis. The transaction status represents the state of the transaction. The state of the transaction includes, for example, entry to the store, shopping in progress, payment in progress, exit from the store, and the like. The entry to the store represents the state until the first registration processing of a merchandise item is performed after the use is started. The shopping in progress represents the state where registration processing of a merchandise item is being performed for the transaction at the POS terminal 2. The payment in progress represents the state where payment processing is being performed for the transaction at the POS terminal 2. The exit from the store represents the state where transaction processing such as the registration processing and the payment processing of the merchandise item is finished for the transaction at the POS terminal 2. The transaction details information includes information about a registered merchandise item (hereinafter, merchandise information), information of the payment processing, or the like. The merchandise information of the registered merchandise item includes merchandise identification information, the number of merchandise items, the price of the merchandise item, and the like. The merchandise identification information is unique identification information allocated on a per merchandise item basis in order to identify each merchandise item. The transaction details information can be updated, based on a user operation at the POS terminal 2. The user operation includes a merchandise registration operation such as registration of a merchandise item, change in the number of items, or cancellation. The merchandise registration operation includes a plus operation (adding an item) and a minus operation (removing an item). The plus operations include a registration operation on a merchandise item and an operation of increasing the number of merchandise items (quantity) of the same type being purchased. The minus operation can be a cancellation operation on a merchandise item or an operation of reducing the number of merchandise items (quantity) of the same type being purchased. The information of the payment processing is detailed information about the payment processing.

The auxiliary memory device 23 stores a user operation history of the user of the POS terminal 2. The user operation history includes a history of the merchandise registration operations by the user of the POS terminal 2. The merchandise registration operation can be a plus operation or a minus operation. The auxiliary memory device 23 can update the user operation history every time a user operation is acquired. The user operation history is also referred to simply as an operation history.

The auxiliary memory device 23 stores weighing information for the POS terminal 2. The weighing information includes weight data representing the weight in the cart 5 detected by the weighing device 3. The weight data is data outputted in time series from the weighing device 3. The weighing information may also include the date and time of detection of the weight data. The weighing information may also include the result of a detection of a change in weight in the cart 5. The result of detection of a change in weight may be an increase in weight, a decrease in weight, no change in weight, or the like. The result of detection of a change in weight may include the value of the weight. The result of detection of a change in weight may include the value of the changed weight (amount of change). The auxiliary memory device 23 can update the weighing information every time the weight data is acquired from the weighing device 3. The auxiliary memory device 23 may update the weighing information every time a result of a detection of a change in weight is acquired from the weighing device 3. The auxiliary memory device 23 can hold (store) the weighing information for a predetermined holding period. The auxiliary memory device 23 can delete the weighing information after the lapse of the holding period.

The auxiliary memory device 23 stores basket weight information about the weight of a shopping basket that can be placed on the cart 5. The basket weight information includes, for example, information of the weight of one shopping basket that can be placed on the cart 5. The basket weight information may also include information of the total weight of a number of shopping baskets that can be placed on the cart 5. In the description below, the weight of one shopping basket that can be placed on the cart 5 is also referred to as basket weight.

The auxiliary memory device 23 stores a merchandise master. The merchandise master stores the merchandise identification information (merchandise code) in correlation with the merchandise information of a merchandise item available at the store. The merchandise information includes the merchandise name, the price, and the like.

The communication interface 24 includes various interfaces that connect the POS terminal 2 communicably with another device via a network in conformity with a predetermined communication protocol. For example, the communication interface 24 connects the POS terminal 2 and an external device communicably via the network. The network may include a wireless network or may include a wired network. The network includes, for example, a LAN (local area network), a Bluetooth (trademark registered) network, a Wi-Fi (trademark registered) network, and the like.

The connection interface 25 is an interface for implementing wired connection between the POS terminal 2 and an external device. The external device includes a scanner 250.

The display device 26 is a device that can display various screens under the control of the processing circuit 21. For example, the display device 26 is a liquid crystal display or EL (electroluminescence) display or the like. The display device 26 is an example of a display unit.

The speaker 27 is a device that can output a sound under the control of the processing circuit 21. The speaker 27 is an example of a sound output device.

The input device 28 is a device that can input data or an instruction to the POS terminal 2. The input device 28 may include a keyboard or a touch panel or the like.

The camera 29 is a device that can acquire captured image data of an image capture area. The camera 29 can capture an image of, for example, a merchandise item in the cart 5.

The hardware configuration of the POS terminal 2 is not limited to the foregoing. In a POS terminal 2, various of the described elements can be omitted, changed, or replaced and additional elements can be added according to need.

The processing circuit 21 in this embodiment executes software instructions the like to implement described functions of a setting unit 210, a merchandise registration processing unit 211, an acquisition unit 212, a display processing unit 213, a first determination unit 214, a second determination unit 215, and an output unit 216. Each unit or function implemented by the processing circuit 21 can also be considered to be implemented by a controller or a control unit incorporating the processing circuit 21 and the main memory 22.

The setting unit 210 configures an initial setting for the detection of a change in weight. The initial setting includes starting synchronization with the weighing device 3. The initial setting includes holding the weight information as of when the synchronization with the weighing device 3 is started. The initial setting includes deleting the previous weighing information. The initial setting includes determining whether the battery value of the weighing device 3 is equal to or lower than a reference value. The reference value can be set by a manager or the like. The setting unit 210 determines whether the weighing device 3 is normally operable. The setting unit 210 may determine whether or not the weighing device 3 is normally operable based on information about the weighing unit 32 and a battery 33 included in the weighing device 3. The setting unit 210 may determine whether the weighing device 3 is normally operable based on information about a motion sensor included in the weighing device 3. The setting unit 210 may output a weighing start instruction to start weighing in the cart 5, to the weighing device 3, based on the determination that the weighing device 3 is normally operable. If it is determined that the weighing device 3 is not normally operable, the setting unit 210 may cause the POS terminal 2 to function as a POS terminal 2 without having a weighing function.

The setting unit 210 ends the synchronization with the weighing device 3 after payment processing is completed. If the payment processing at the POS terminal 2 is complete, the setting unit 210 may delete the weighing information. The setting unit 210 also ends the synchronization with the weighing device 3 if a shopping cancellation operation is performed by the user of the POS terminal 2. If the shopping cancellation operation is performed, the setting unit 210 may delete the weighing information.

The merchandise registration processing unit 211 performs merchandise registration processing, based on a user operation at the POS terminal 2. Specifically, based on the scan of the merchandise code of a merchandise item by the user, the merchandise registration processing unit 211 refers to the merchandise master and acquires transaction merchandise data corresponding to the merchandise code. The transaction merchandise data includes data such as the merchandise code, the merchandise name, the price of the merchandise item, and the number of merchandise items. The merchandise item corresponding to the merchandise code is also referred to as a transaction merchandise item. The merchandise registration processing unit 211 outputs transaction information to the cloud server 1.

The merchandise registration processing unit 211 may also perform the merchandise registration processing in coordination with the cloud server 1. In this case, the merchandise registration processing unit 211 outputs a merchandise registration request to the cloud server 1. The cloud server 1 acquires merchandise information, based on the merchandise code included in the merchandise registration request, and stores transaction information. The cloud server 1 outputs the transaction information to the POS terminal 2. The merchandise registration processing unit 211 stores the transaction information.

The acquisition unit 212 acquires the weighing information from the weighing device 3 via the communication interface 24. The acquisition unit 212 checks the weighing information at a predetermined interval and detects a change in weight in the cart 5. The acquisition unit 212 acquires the result of a detection of weight change detection in the cart 5. The result of the detection can be an increase or decrease in weight based on the weighing information gathered in time series or the like. The value of weight based on the weighing information can be, for example, the median value of a plurality f collected values acquired over time at a plurality of successive timings. The value of weight based on the weighing information may be the average value or the mode value and is not particularly limited. The detection results are not limited to a result indicating an increase or decrease in time series in the value of weight and may simply be a result indicating that there has been a change in weight or may indicate there has been no change in weight. The result of the detection may be no change in weight, an increase in weight, a decrease in weight, or the like. The result of the detection can also include an increase or decrease value (amount) such as “plus 30 grams”. The acquisition unit 212 may acquire the result from the weighing device 3 via the communication interface 24. In this case, the weighing device 3 may detect a change in weight in the cart 5 based on the weight data. The weighing device 3 may output the result of the detection of the change in weight to the POS terminal 2. The POS terminal 2 may determine whether the user operation is appropriate in response to the result of the detection.

The acquisition unit 212 may acquire battery information from the weighing device 3 via the communication interface 24. The battery information includes information indicating a battery value such as the voltage of the battery of the weighing device 3. The acquisition unit 212 may acquire payment completion information indicating that the payment processing is complete, from the cloud server 1 via the communication interface 24. In this context, “acquire” may be considered to refer to “calculate”.

The display processing unit 213 processes the display on the display device 26. The display processing unit 213 displays various notifications on the display device 26. The display processing unit 213 displays a notification about a shopping basket on the display device 26. The notification about a shopping basket includes, for example, a notification to prompt the user to place a shopping basket on the cart 5. The notification to prompt the user to place a shopping basket on the cart 5 is also referred to as a basket check notification. The basket check notification includes, for example, a message such as “Place a shopping basket on the cart.” The basket check notification may include a message such as “If you use two shopping baskets, place two.” The basket check notification is an example of a first notification about the shopping basket. The notification about the shopping basket includes, for example, a notification to check whether a shopping basket has been placed on the cart 5. The notification to check whether or not a shopping basket has been placed on the cart is also referred to as a basket addition check notification. The basket addition check notification includes, for example, a message such as “Did you place a shopping basket?” The basket addition check notification is an example of a second notification about the shopping basket. The notification about the shopping basket includes, for example, a notification to prompt the user to correctly place a shopping basket on the cart 5. The notification to prompt the user to correctly place a shopping basket on the cart 5 is also referred to as a basket error notification. The basket error notification includes, for example, a message such as “Place a shopping basket correctly.”

The display processing unit 213 displays a different notification than the notification about the shopping basket on the display device 26. Here, the different notification includes, for example, a notification to notify the user of failure to register a merchandise item. A notification to notify the user of failure to register a merchandise item is also referred to as a failure-to-scan notification. The failure-to-scan notification may be or include a message such as “A merchandise item is added to the cart. Register the merchandise item.” The different notifications than those about the shopping basket can be, for example, a warning notification. A warning notification may be a notification to call the user's attention to certain issues related to the appropriate use of the cart 5. The warning notification can be a message such as “Getting on the cart is dangerous.”

The display processing unit 213 displays a notification on the display device 26 based on determination by the first determination unit 214.

The first determination unit 214 determines a change in weight in the cart 5 based on detection of a change in weight in the cart 5. The first determination unit 214 may determine whether an increase or decrease in weight in the cart 5 should be considered to have occurred based on a preset threshold change amount. A case where a threshold to determine that there is an increase is “plus 25 grams” and the threshold to determine that there is a decrease is “minus 25 grams” will now be described. If the weight change plus value is 25 grams or more, the first determination unit 214 determines that there has been an increase in weight. If the weight change minus value is 25 grams or more, the first determination unit 214 determines that there has been a decrease in weight. If the magnitude of the detected change is less than 25 grams, it is determined there has been no weight change.

The first determination unit 214 determines whether a shopping basket set on the cart 5 or not by referring to the basket weight information. The first determination unit 214 determines whether the change (increase) in weight is equivalent to the weight of a basket. The weight change equivalent to the basket is also referred to as a basket equivalent weight. The basket equivalent weight is, for example, the weight of one shopping basket, the weight of two shopping baskets, or other multiples or the like. The basket equivalent weight may also be a weight range. The basket equivalent weight may also be set to a nominal basket weight with a margin of error thereabout. The basket equivalent weight may be, for example, a range of plus/minus 5 grams from the nominal basket weight or expected basket weight. The basket equivalent weight can vary depending on the number of baskets that can be set on the cart 5. A case where the number of baskets that can be set on the cart 5 is two and where the basket weight is 200 grams will now be described. The basket equivalent weight is, for example, 200 grams, 400 grams, 195 grams to 205 grams, 395 grams to 405 grams, or the like. As the basket equivalent weight, a different weight may be set for each store. The basket equivalent weight may be an average basket weight for baskets used at the store plus/minus an expected variation. The auxiliary memory device 23 may store basket equivalent weight information including the basket equivalent weight. In this case, the first determination unit 214 may determine whether a shopping basket has been set on the cart 5 or not by referring to the basket equivalent weight information.

The first determination unit 214 determines that a shopping basket is set on the cart 5, if the amount of change in weight in the cart 5 is the basket equivalent weight or within the range of the basket equivalent weight. The first determination unit 214 determines that a shopping basket is not set on the cart 5, if the amount of change in weight in the cart 5 is not the basket equivalent weight or not within the range of the basket equivalent weight.

The first determination unit 214 may also determine whether an appropriate user operation corresponding to the detection of the change in weight in the cart 5 has been performed. The first determination unit 214 may check whether there is a change in weight or not based on the detection, and may determine whether the user operation is appropriate or not in response to the result of the detection. For example, the first determination unit 214 may determine that the user operation is appropriate if the weight in the cart 5 is increased and the plus operation is performed by the user. The first determination unit 214 may determine that the user operation is not appropriate if the weight in the cart 5 is increased but the plus operation is not performed by the user.

The first determination unit 214 may perform a determination corresponding to the change in weight during a predetermined time based on the detection of the change in weight in the cart 5. A case where an increase or decrease in weight is detected within a predetermined time will now be described. If no user operation is performed, the first determination unit 214 may determine that there is an error. The determination that there is an error can be a determination that the user operation is not appropriate or that the use of the cart is not appropriate. A user operation is not appropriate when, for example, there is a failure to scan, a failure to cancel a merchandise item, or the like. The use of the cart is not appropriate when, for example, a person gets into the cart, excess weight is put on the cart, or the like.

The second determination unit 215 determines the start of the merchandise registration processing based on the determination by the first determination unit 214. The second determination unit 215 determines that the merchandise registration processing can be when started the first determination unit 214 determines that a shopping basket has been set on the cart 5. If it is determined that the merchandise registration processing can be started, the second determination unit 215 may instruct the weighing device 3 to start weighing on the cart 5. If it is determined that the merchandise registration processing can be started, the second determination unit 215 may enable the acceptance of the merchandise registration operation by the user.

The output unit 216 outputs the transaction information to the cloud server 1 via the communication interface 24. The output unit 216 may output the weighing information to the cloud server 1 via the communication interface 24. The output unit 216 may output the result of the detection of the change in weight in the cart 5 to the cloud server 1 via the communication interface 24. In this case, the POS terminal 2 may display a notification on the display device 26, based on an instruction from the cloud server 1.

An example of the configuration of the weighing device 3 will now be described.

The weighing device 3 includes control board 31, weighing unit 32, battery 33, and a communication interface 34. The elements forming the weighing device 3 are connected in such a way as to be able to input and output a signal from and to each other.

The control board 31 controls each sub-component of the weighing device 3.

The weighing unit 32 acquires the weight data for the cart 5. The weighing unit 32 outputs the weighing information including the weight data to the POS terminal 2 at a fixed time interval. The time interval can be an interval of 200 milliseconds or an interval of 100 milliseconds or the like. If the cart has an upper tier and a lower tier, the weighing unit 32 can simultaneously measure the weight on the upper tier and the weight on the lower tier. The weighing unit 32 may detect a change in weight in the cart 5, based on the weight data. In this case, the weighing unit 32 may output the result of the detection of the change in weight to the POS terminal 2. The weighing unit 32 can separately measure the weight on the upper tier and the weight on the lower tier of the cart. In this case, a weighing unit 32 may be installed for each of the upper tier and the lower tier of the cart.

The battery 33 is a rechargeable power supply source.

The communication interface 34 is an interface to connect the weighing device 3 and an external device. The communication interface 34 communicably connects the weighing device 3 and the POS terminal 2, for example, via a network such as a Bluetooth (trademark registered) network. The communication interface 34 may connect the weighing device 3 and the POS terminal 2 via a wire.

The weighing device 3 may include a motion sensor to increase the weighing accuracy. The motion sensor can detect the stop and movement of the cart 5. The weighing unit 32 may acquire the weight data of the cart 5 if the cart 5 is stopped.

The hardware configuration of the weighing device 3 is not limited to the foregoing configuration. In the weighing device 3, any one of the foregoing elements can be omitted or changed and a new element can be added according to need.

### Example of Operation

In the description below where cloud server 1 is the mentioned, the reference to cloud server 1 may be considered to refer to a processing circuit or the like of the cloud server 1. Similarly, in where the POS terminal 2 is referenced, the this may be considered to refer to the processing circuit 21 of the POS terminal 2.

The processing procedures described in this example are non-limiting. The described processing may be varied or altered. For example, a described process can be omitted, replaced, or moved according to the need of the particular embodiment and additional processing may be added or included.

In the described example below, it is assumed that the user of the POS terminal 2 shops at a “store A.”

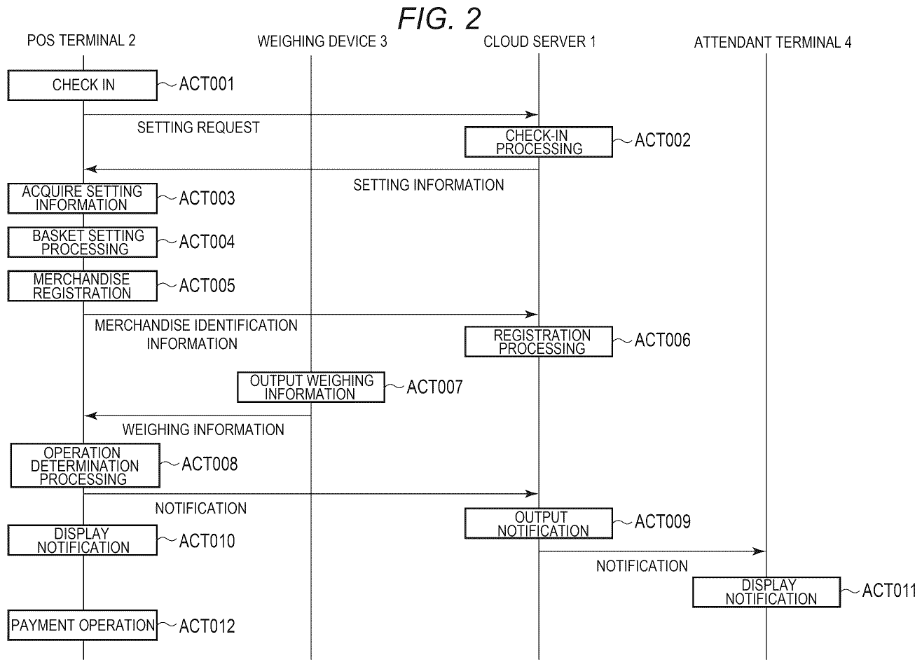

FIG. 2 is a sequence chart illustrating procedures of information processing at the start of shopping in the information processing system 100 according to the embodiment.

The user of the POS terminal 2 acquires a check-in code represented by a barcode or a two-dimensional code or the like placed at the entrance of the store A and thus checks in. The check-in code includes, for example, a business code, a store code, and information for the POS terminal 2 to connect to the cloud server 1 via a network. For example, when the user starts a dedicated application program at the POS terminal 2, a screen to read the check-in code is displayed on the display device 26. The user operates the POS terminal 2 to read the check-in code and thus checks in. That is, the application at the POS terminal 2 sends a setting request to the cloud server 1, based on the information read from the check-in code. Alternatively, the user may check in via a check-in device installed at the entrance of the store A. For example, when the user starts a dedicated application program at the POS terminal 2, a barcode or a two-dimensional code or the like representing the member ID is displayed on the display device 26. The user causes the check-in device to read the member ID and thus checks in. Alternatively, the POS terminal 2 may automatically specify the corresponding store, based on location information of the POS terminal 2, as check-in processing. For example, the POS terminal 2 may transmit location information with the setting request to the cloud server 1, and the cloud server 1 may identify the store based on the location of the POS terminal 2 for user check in. The check-in processing may be performed by other processing.

The POS terminal 2 performs check-in processing upon a check-in operation being performed by the user (ACT 001). When the check-in processing is started, the output unit 216 of the POS terminal 2 outputs a setting request to the cloud server 1. The setting request requests a retrieval of setting information related to conditions and parameters for performing the detection of changes in weight in the cart 5 that is correlated with the POS terminal 2. The setting request may also include information related to determinations of operations at the POS terminal 2. The condition settings includes a setting for the determination to perform error processing in the case of a failure to scan or the like. The setting request can include the identification information of the POS terminal 2. The setting request can include the identification information of the cart 5 to which the POS terminal 2 is attached. The setting request can include the basket weight information for a shopping basket that can be placed on the cart 5.

The cloud server 1 performs the check-in processing (ACT 002). The cloud server 1 identifies, for example, the business and the particular store of the POS terminal 2 and this enables the appropriate merchandise master to be referred to for the POS terminal 2. The cloud server 1 outputs the setting information to the POS terminal 2. The cloud server 1 also provides a transaction code. The cloud server 1 generates to the identification transaction information correlated information of the POS terminal 2 and the transaction code. In some cases, the user of the POS terminal 2 may start shopping without checking in. For example, the appropriate setting information may be set in advance in the POS terminal 2, and in this case, the check-in operation in ACT 001 and the check-in processing in ACT 002 can be omitted.

The acquisition unit 212 of the POS terminal 2 acquires the setting information (ACT 003). The setting unit 210 of the POS terminal 2 configures the POS terminal 2 according to the various settings based on the acquired setting information.

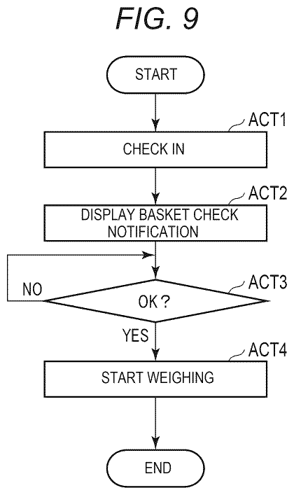

The POS terminal 2 performs basket setting processing (ACT 004). Here, the basket setting processing can be as shown in FIGS. 9 to 13. The basket setting processing includes displaying a notification about the shopping basket on the display device 26.

The merchandise registration processing unit 211 of the POS terminal 2 then performs merchandise registration processing based on user operations (ACT 005). The output unit 216 of the POS terminal 2 outputs a merchandise registration request to the cloud server 1 when an item of merchandise is registered by the user at the POS terminal 2. The merchandise registration request causes the cloud server 1 to register a merchandise item to be purchased by the user. The merchandise registration request may include merchandise identification information such as the merchandise code of the registered item.

A registration processing unit 111 of the cloud server 1 performs registration processing based on the merchandise registration request (ACT 006). In particular, in this example, cloud server 1 acquires the merchandise information from the merchandise master for the merchandise identification information included in the merchandise registration request sent from the POS terminal 2 and adds this merchandise information for the registered item to the transaction information. The transaction information can be stored in an auxiliary memory device 13 and updated as necessary when additional registration requests or the like are received by the cloud server 1.

The weighing device 3 outputs the weighing information (weight information or the measured weight) to the POS terminal 2 at a fixed time interval (ACT 007). The weighing device 3 detects a change in measured weight based on the merchandise item(s) put in the cart 5. The weighing device 3 may output the detected change in weight to the POS terminal 2. The POS terminal 2 may determine whether the user operation is appropriate or not based on the result of the weight detection (e.g., the POS terminal 2 may compare the expected weight of the registered item to the detected weight change in the cart 5).

The POS terminal 2 now performs operation determination processing (ACT 008). The POS terminal 2 determines (detects) whether an unauthorized operation has been performed by the user or not. The POS terminal 2 can determine whether an unauthorized operation has been performed or not based on the detected change in weight and the use operations at the POS terminal 2. The unauthorized operation can be an operation that does not match or correspond to the change in weight in the cart 5. For example, the unauthorized operation can be a cancellation operation, a number-of-items decrease operation, or the absence of an expected operation or the like after an increase in weight in the cart 5. In this case, it is conceivable that the user simply forgot to perform the registration operation for a merchandise item (failure to scan), performed the cancellation operation by mistake, or performed the number-of-items decrease operation by mistake, when the merchandise item was put in the cart. The unauthorized operation can be a registration operation, a number-of-items increase operation, or the absence of an expected operation or the like after a decrease in weight in the cart 5. If an unauthorized operation is performed, the POS terminal 2 outputs a notification to the cloud server 1.

The cloud server 1 acquires the unauthorized operation notification. The cloud server 1 outputs this notification to the attendant terminal 4 (ACT 009).

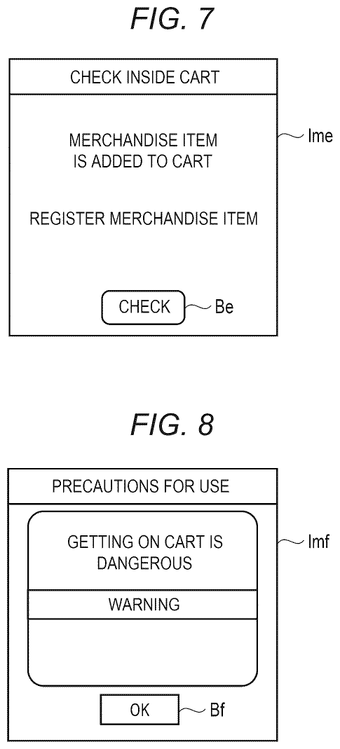

The POS terminal 2 may display a notification about unauthorized operation on the display device 26 based on the operation determination processing (ACT 010). The notification can be an error notification about an unauthorized operation by the user of the POS terminal 2. For example, the notification indicates that an operation corresponding to the change in weight was not performed. Specifically, if the weight in the cart 5 is decreased and an item removal operation (minus operation), such as a cancellation operation, is not performed by the user, it may be determined or suspected that a merchandise item was taken out of the cart. The removal operation can be a cancellation operation or a number-of-items decrease operation. Therefore, the notification includes a message prompting the user to perform a removal operation. For example, the notification displayed on the display device 26 includes text such as “Did you take out a merchandise item from the cart? The cancellation operation is not done. Cancel the corresponding merchandise item.” The notification displayed on the display device 26 can instead be a failure-to-scan notification image Ime (as shown in FIG. 7) when the weight in the cart 5 is increased but an item addition operation (a plus operation) such as a registration operation is not performed by the user. The POS terminal 2 may output the notification as a sound, images, or a video.

The attendant terminal 4 displays the notification about the unauthorized operation on a display device (ACT 011). The attendant terminal 4 may output this notification as a sound, images, or a video. The user of the attendant terminal 4 checks the notification and may then attempt to check the cart 5 corresponding to the POS terminal 2 in question according to perceived need.

The POS terminal 2 performs a payment operation based on a user operation (ACT 012). The POS terminal 2 may output a payment operation notification (payment completion notification) to the cloud server 1 indicating that the payment operation was performed. The POS terminal 2 may detect the start of a payment operation by user operations such as a press of a payment button by the user. The POS terminal 2 can then process the settlement of the transaction. In this context, settlement is the receiving and handling of a payment for the transaction. Payment may be made by any of a plurality of methods such as offline (e.g., cash) payments or online (credit card, electronic money, etc.) payments.

### Example of Display

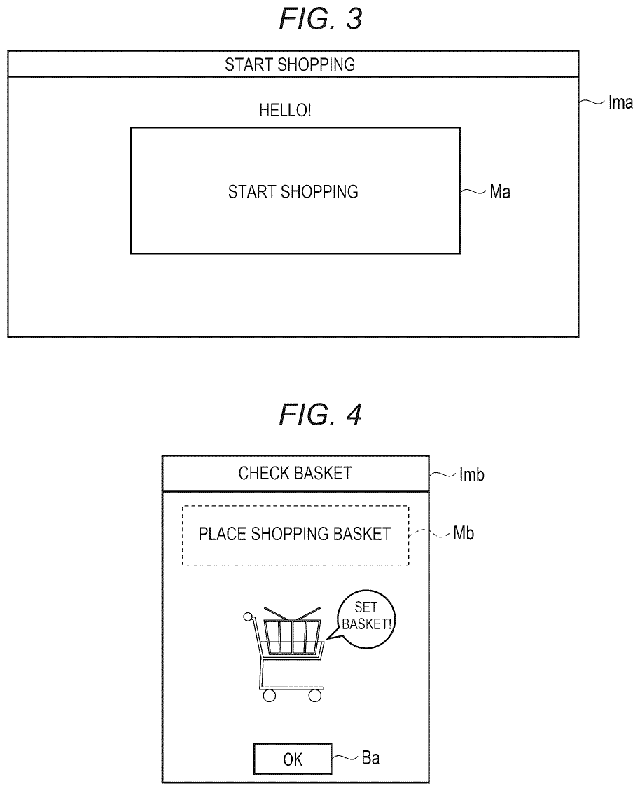

FIG. 3 is a schematic view showing an example of a shopping start image displayed at the POS terminal 2 according to the embodiment. FIG. 3 shows a shopping start image Ima displayed on the display device 26 at the start of shopping, at the POS terminal 2. The shopping start image Ima includes a notification Ma.

The notification Ma includes message text such as “Start shopping.” The notification Ma may include a button for the user to input an operation to “start shopping”. The button for the user to input the operation to “start shopping” may include an “OK” button.

The user of the POS terminal 2 performs an operation of selecting the “OK” button by a touch input or the like. The “OK” button is a button that can input a shopping start instruction via the input device 28. The touch input on the “OK” button is an example of the shopping start instruction. The user of the POS terminal 2 may perform an operation of selecting the notification Ma by a touch input or the like and thus input the shopping start instruction. FIG. 3 illustrates the case where the notification Ma also functions as the “OK” button to input the shopping start instruction.

FIG. 4 is a schematic view showing an example of a notification image displayed at the POS terminal 2 according to the embodiment. FIG. 4 shows a basket check notification image Imb displayed on the display device 26 before the user begins registration of a merchandise item at the POS terminal 2. The basket check notification image Imb includes a notification Mb.

The notification Mb includes message text such as “Place a shopping basket.” The basket check notification image Imb includes an “OK” button Ba. The “OK” button Ba is a button that can input an instruction to hide the display of the notification Mb. Hiding the display can include erasing the display.

Whether to display the basket check notification image Imb may be set on a per store basis.

In this case, the user of the POS terminal 2 sets a shopping basket on the cart 5 and then selects the “OK” button Ba by a touch input or the like. The POS terminal 2 may display the “OK” button Ba in a user-selectable mode constantly or for a predetermined timing. Here, displaying in a user-selectable mode includes, for example, displaying the “OK” button Ba in an operable mode or permitting the user to otherwise clear or hide the screen or the button by a user operation. Displaying in a non-selectable mode includes, for example, displaying the “OK” button Ba in an inoperable mode, for example, graying out the button or the like, or otherwise displaying a mode in which the notification, screen, or button cannot be cleared or hidden by a user operation. The predetermined timing in this context can be, for example, until the processing circuit 21 of the POS terminal 2 determines that a basket has been set on the cart 5.

The first determination unit 214 may determine that the user operation is not appropriate if the weight in the cart 5 is increased but a plus operation is not performed by the user.

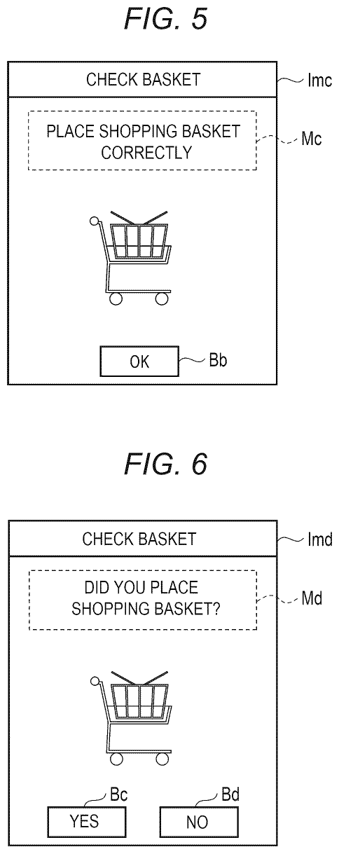

FIG. 5 is a schematic view showing an example of the notification image displayed at the POS terminal 2 according to the embodiment. FIG. 5 shows a basket error notification image Imc displayed on the display device 26 before the user registers a merchandise item, at the POS terminal 2. The basket error notification image Imc includes a notification Mc.

The notification Mc includes a message text such as “Place a shopping basket correctly.” The basket error notification image Imc includes an “OK” button Bb. The “OK” button Bb is a button that can input an instruction to hide the display of the notification Mc, via the input device 28.

The processing circuit 21 of the POS terminal 2 displays the basket error notification image Imc on the display device 26, for example, if a weight that deviates from the basket equivalent weight is detected after the basket check notification image Imb shown in FIG. 4 is displayed on the display device 26.

The user of the POS terminal 2 sets a shopping basket on the cart 5 and subsequently performs an operation of selecting the “OK” button Bb by a touch input or the like. The POS terminal 2 may display the “OK” button Bb in a user-selectable mode constantly or at a predetermined timing.

FIG. 6 is a schematic view showing an example of the notification image displayed at the POS terminal 2 according to the embodiment. FIG. 6 shows a basket addition check notification image Imd displayed on the display device 26 after the start of shopping, at the POS terminal 2. The basket addition check notification image Imd includes a notification Md.

The notification Md includes message text such as “Did you place a shopping basket?” The basket addition check notification image Imd includes a “YES” button Bc and a “NO” button Bd. The “YES” button Bc is a button that can input information indicating that a shopping basket is placed, via the input device 28. The “NO” button Bd is a button that can input information indicating that a shopping basket is not placed, via the input device 28.

The processing circuit 21 of the POS terminal 2 displays the basket addition check notification image Imd, for example, if an increase in the basket equivalent weight in the cart 5 is detected during shopping. During shopping is an example of the time during which the user registers a merchandise item.

The user of the POS terminal 2 performs an operation of selecting the “YES” button Bc by a touch input or the like if the user adds a shopping basket to the cart 5. The user of the POS terminal 2 performs an operation of selecting the “NO” button Bd by a touch input or the like if the user does not add a shopping basket to the cart 5. If the user of the POS terminal 2 selects the “YES” button Bc, the processing circuit 21 may determine that the detected change in weight is due to the addition of a shopping basket. If the user of the POS terminal 2 selects the “NO” button Bd, the processing circuit 21 may determine that the detected change in weight is due to the addition of a merchandise item.

FIG. 7 is a schematic view showing an example of the notification image displayed at the POS terminal 2 according to the embodiment. FIG. 7 shows a failure-to-scan notification image Ime displayed on the display device 26 after the start of shopping, at the POS terminal 2.

The failure-to-scan notification image Ime shows that an operation corresponding to the change in weight is not performed. The failure-to-scan notification image Ime is an image shown when the weight in the cart 5 is increased and a plus operation (such as the registration operation) is not performed by the user. In this case, it is estimated that the merchandise item put in the cart is not registered. The operation corresponding to the change (increase) in weight is the plus operation such as the registration operation or the number-of-items increase operation. The failure-to-scan notification image Ime includes a message notifying the user of failure to scan or a message prompting the user to perform the plus operation. The failure-to-scan notification image Ime includes message text such as “A merchandise item is added to the cart. Register the merchandise item.” The failure-to-scan notification image Ime may include a “CHECK” button Be. The “CHECK” button Be is a button for an instruction to hide the display of the failure-to-scan notification image Ime.

The user of the POS terminal 2 checks the failure-to-scan notification image Ime and performs the registration operation or the like. The processing circuit 21 of the POS terminal 2 may hide the failure-to-scan notification image Ime after the lapse of a predetermined time or may hide the failure-to-scan notification image Ime, based on a selection operation to select the “CHECK” button by the user.

FIG. 8 is a schematic view showing an example of the notification image displayed at the POS terminal 2 according to the embodiment. FIG. 8 shows a warning notification image Imf displayed on the display device 26 after the start of shopping, at the POS terminal 2.

The warning notification image Imf shows a notification to call the user's attention to the use of the cart 5. The processing circuit 21 of the POS terminal 2 may display the warning notification image Imf on the display device 26 before the user registers a merchandise item. The processing circuit 21 may display the warning notification image Imf on the display device 26 if a predetermined weight is detected during shopping. The predetermined weight is, for example, a weight heavier than the weight expected for a common merchandise item. Here, the predetermined weight is set to a weight indicating there is a need to call the user's attention to appropriate use of the cart when exceeded. The predetermined weight may be, for example, an expected weight when a person gets on the cart or an expected weight expected to be on the cart when a person puts a foot on the cart, or the like. For example, if a foot is put on the cart or a person gets on the cart, the weight changes. Therefore, if the weight changes by 1 kilogram or 5 kilograms or more for some predetermined length of time and therefore other weight changes cannot be specified, it may be assumed that a foot has been put on the cart. The predetermined weight is, for example, 1 kilogram or 5 kilograms or the like. This predetermined weight can be set according to need.

The warning notification image Imf includes message text such as “Getting on the cart is dangerous.” The warning notification image Imf may include an “OK” button Bf. The “OK” button Bf is a button that can input an instruction to hide the display of the warning notification image Imf.

The user of the POS terminal 2 checks the warning notification image Imf and checks the way to use the cart. The processing circuit 21 of the POS terminal 2 may hide the warning notification image Imf after the lapse of a predetermined time or may hide the warning notification image Imf, based on a selection operation to select the “OK” button Bf by the user. The processing circuit 21 may display the “OK” button Bf in a user-selectable mode constantly or at a predetermined timing. The predetermined timing includes, for example, the timing when it is determined by the processing circuit 21 of the POS terminal 2 that the weight in the cart 5 is decreased.

### Example of Operation

Procedures of processing in the information processing system 100 will now be described.

The processing procedures described in this example are non-limiting. The described processing may be varied or altered. For example, a described process can be omitted, replaced, or moved according to the need of the particular embodiment and additional processing may be added or included.

In the examples described below, it is assumed that the user of the POS terminal 2 shops at store A.

First to fourth modes of information processing in the information processing system 100 at the start of shopping will now be described.

First, the user of the POS terminal 2 checks in via a check-in device installed at the entrance of the store A. The user of the POS terminal 2 may start shopping without checking in.

The user sets a shopping basket on the cart 5. It is assumed that shopping baskets are placed near the entrance of the store A. Shopping baskets may be placed at a location near the cart storage space for the cart 5 or may be placed at a location distant from the cart storage space for the cart 5. The user sets a shopping basket on the cart 5 and starts shopping in the store A.

The POS terminal 2 calls the user's attention to the setting of a shopping basket on the cart 5 before the user registers a merchandise item. In this context, “before the user registers a merchandise item” can mean before the user puts a merchandise item into the shopping basket for purchase, after check-in but after a shopping start instruction has been entered, or Here, “after check-in” can be, for example, after a dedicated application program is started by the user or after the member ID of the user has been read via the check-in device. The POS terminal 2 may acquire a shopping start instruction based on some user operation. Calling for the user's attention is, for example, displaying the basket check notification or the like.

FIG. 9 is a flowchart illustrating the first mode of information processing by the POS terminal 2 according to the embodiment. The first mode is a mode in which, based on a shopping start operation by the user, for example, the basket check notification as shown in FIG. 4 is displayed on the display device 26 before the user registers a merchandise item.

The processing circuit 21 acquires a shopping start instruction, based on a shopping start operation by the user in the shopping start image displayed on the display device 26 (ACT 1). The processing circuit 21 may output the shopping start instruction to the cloud server 1.

The processing circuit 21 displays the basket check notification on the display device 26 (ACT 2). The processing of ACT 2 may be performed by the display processing unit 213. In ACT 2, for example, the processing circuit 21 displays the basket check notification on the display device 26, based on the acquisition of the shopping start instruction. The processing circuit 21 displays the basket check notification on the display device 26 after the shopping start operation by the user. The processing circuit 21 may output the notification as a sound via the speaker 27 in addition to or instead of the display of the notification.

The processing circuit 21 determines whether the “OK” button has been operated by the user (ACT 3). The processing of ACT 3 may be performed by the display processing unit 213. If the processing circuit 21 determines that the “OK” button is operated (YES in ACT 3), the processing shifts from ACT 3 to ACT 4. If the processing circuit 21 determines that the “OK” button is not operated (NO in ACT 3), the processing repeats ACT 3. The operation of the “OK” button corresponds to an instruction to hide the basket check notification.

The processing circuit 21 causes the weighing device 3 to start detecting the weight in the cart 5 (ACT 4). The processing of ACT 4 may be performed by the setting unit 210. In ACT 4, for example, the processing circuit 21 configures an initial setting for the detection of a change in weight, based on the operation of the “OK” button by the user. For example, the initial setting may include setting the weight detected by the weighing unit 32 to zero. The weighing device 3 may start detecting the weight in the cart 5 after setting the weight detected by the weighing unit 32 to zero. The processing circuit 21 may start synchronization with the weighing device 3. The processing circuit 21 starts communication with the weighing device 3 via the communication interface 24, based on the synchronization between the POS terminal 2 and the weighing device 3. The weighing device 3 detects the weight in the cart 5.

The processing circuit 21 performs the merchandise registration processing, based on the merchandise registration operation by the user.

In this example, the POS terminal 2 can display the basket check notification on the display device 26 before the user registers a merchandise item. Therefore, the POS terminal 2 can prompt the user to place a basket on the cart, before starting weighing due to merchandise registration. Thus, the POS terminal 2 can suppress an error indication based on a change in weight in the cart due to the placement of a basket on the cart.

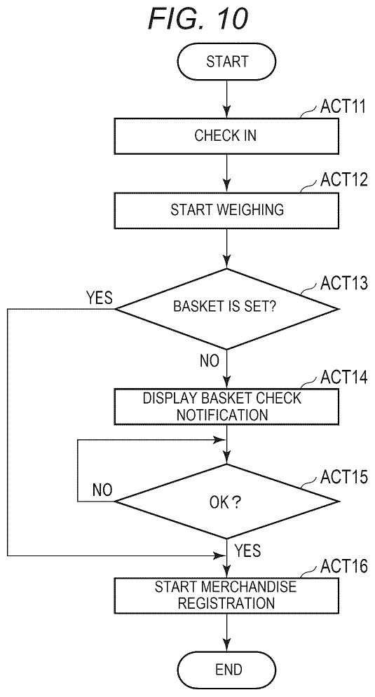

FIG. 10 is a flowchart illustrating the second mode of information processing by the POS terminal 2 according to the embodiment. The second mode is a mode in which the weighing device 3 is made to start weighing, based on a shopping start operation by the user. The second mode is a mode in which, for example, the basket check notification as shown in FIG. 4 is not displayed if a basket is set on the cart 5 before the user registers a merchandise item.

The processing circuit 21 acquires a shopping start instruction, based on a shopping start operation by the user in the shopping start image displayed on the display device 26 (ACT 11), as in ACT 1.

The processing circuit 21 causes the weighing device 3 to start detecting the weight in the cart 5 (ACT 12), as in ACT 4. The weighing device 3 detects the weight in the cart 5.

The processing circuit 21 determines whether a shopping basket has been set on the cart 5 or not based on the detection of the change in weight in the cart 5 (ACT 13). The processing of ACT 13 may be performed by the first determination unit 214. In ACT 13, for example, the processing circuit 21 acquires the basket weight information. The processing circuit 21 determines whether the change (increase) in weight in the cart 5 is the basket equivalent weight or not. If the change (increase) in weight in the cart 5 is the basket equivalent weight, the processing circuit 21 determines that a shopping basket was set on the cart 5. The processing circuit 21 may determine whether a shopping basket has been set on the cart 5 based on whether there is a change (increase) in weight in the cart 5 within a predetermined period or not. The predetermined period can be set on a per store basis. If the change (increase) in weight in the cart 5 is not the basket equivalent weight, the processing circuit 21 determines that a shopping basket was not set on the cart 5. The processing circuit 21 may determine that a shopping basket is on the cart 5 if there was no change (increase) in weight in the cart 5 within a predetermined period. In this case, the basket equivalent weight is the weight of one shopping basket, a weight equivalent to the weight of two shopping baskets, or a weight acquired by adding a margin of error (tolerance value) to one of these weights. If the processing circuit 21 determines that a shopping basket has been set on the cart 5 (YES in ACT 13), the processing shifts from ACT 13 to ACT 16. If the processing circuit 21 determines that a shopping basket has not been set on the cart 5 (NO in ACT 13), the processing shifts from ACT 13 to ACT 14. If a weight that is not the basket equivalent weight is detected, such a when merchandise item is put into the cart 5 before a shopping basket is set on the cart 5, or the like, the processing circuit 21 may determine that it is not the basket equivalent weight and may give a notification without performing merchandise registration. In this case, the notification is, for example, the basket error notification as shown in FIG. 5.

The processing circuit 21 displays the basket check notification on the display device 26 based on the determination (ACT 14). The processing of ACT 14 may be performed by the display processing unit 213. The processing circuit 21 displays the basket check notification after the shopping start operation by the user. In a specific example, the processing circuit 21 displays the basket check notification after the weighing device 3 starts weighing. The processing circuit 21 may output the notification as a sound via the speaker 27 in addition to or instead of the display of the notification. If a user operation is detected before the basket equivalent weight is detected, for example, if a user operation (scan, key operation or the like) for the registration of a merchandise item or the like before a shopping basket is set on the cart 5, or the like, the processing circuit 21 may give a notification. In this case, the notification is, for example, the basket error notification as shown in FIG. 5.

The processing circuit 21 determines whether the “OK” button is operated by the user or not (ACT 15). The processing of ACT 15 may be performed by the display processing unit 213. If the processing circuit 21 determines that the “OK” button is operated (YES in ACT 15), the processing shifts from ACT 15 to ACT 16. If the processing circuit 21 determines that the “OK” button is not operated (NO in ACT 15), the processing repeats ACT 15.

The processing circuit 21 determines that the merchandise registration processing can be started based on the determination by the first determination unit 214 (ACT 16). In some examples, processing of ACT 16 may be performed by the second determination unit 215. The processing circuit 21 may enable the acceptance of the merchandise registration operation by the user.

In this example, if the POS terminal 2 determines that a basket was placed on the cart based on the detection of a change in weight in the cart before the user registers a merchandise item, the POS terminal 2 does not display the basket check notification on the display device 26. If the POS terminal 2 determines that a basket is not placed on the cart based on the detection of a change in weight in the cart before the user registers a merchandise item, the POS terminal 2 can display the basket check notification on the display device 26. Therefore, the POS terminal 2 can prompt the user to place a basket on the cart if a basket is not placed on the cart, before starting weighing due to merchandise registration. Thus, the POS terminal 2 can determine whether to display or hide the basket check notification in response to the detection of a change in weight in the cart. The POS terminal 2 can omit the display processing for the notification based on the detection of a change in weight in the cart. Also, the POS terminal 2 can hold the basket weight in advance and thus can suppress an error indication based on a change in weight in the cart due to the placement of a basket on the cart.

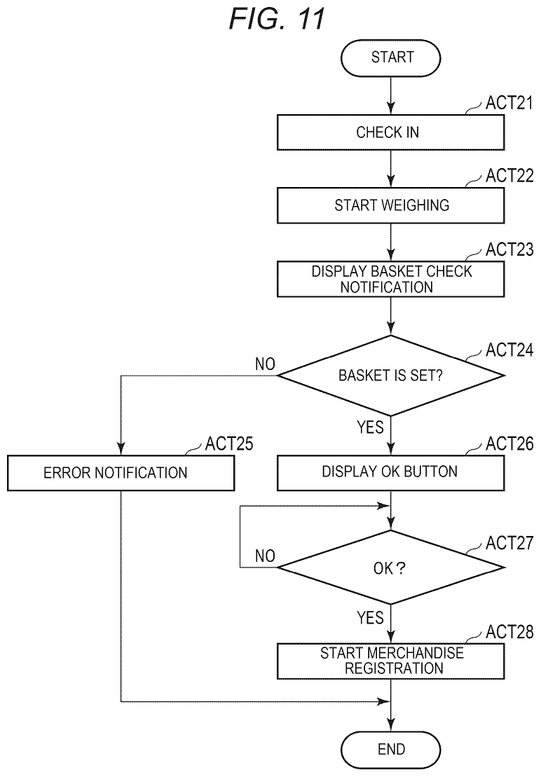

FIG. 11 is a flowchart illustrating the third mode of information processing by the POS terminal according to the embodiment. The third mode is a mode in which the weighing device 3 is made to start weighing, based on a shopping start operation by the user. The third mode is a mode in which the basket check notification is displayed before the user registers a merchandise item and in which the input of an instruction to hide the basket check notification is enabled if a basket is set on the cart 5 by the user.

The processing circuit 21 acquires a shopping start instruction, based on a shopping start operation by the user in the shopping start image displayed on the display device 26 (ACT 21), as in ACT 1.

The processing circuit 21 causes the weighing device 3 to start detecting the weight in the cart 5 (ACT 22), as in ACT 4. The weighing device 3 detects the weight in the cart 5.

The processing circuit 21 displays the basket check notification on the display device 26 (ACT 23). The processing of ACT 23 may be performed by the display processing unit 213. The processing circuit 21 displays the basket check notification after the shopping start operation by the user. In a specific example, the processing circuit 21 displays the basket check notification after the weighing device 3 starts weighing. The processing circuit 21 may output the notification as a sound via the speaker 27 in addition to or instead of the display of the notification.

The processing circuit 21 determines whether a shopping basket has been set on the cart 5 or not based on the detection of a change in weight in the cart 5 (ACT 24), as in ACT 13. The processing of ACT 24 may be performed by the first determination unit 214. If the processing circuit 21 determines that a shopping basket is set on the cart 5 (YES in ACT 24), the processing shifts from ACT 24 to ACT 26. If the processing circuit 21 determines that a shopping basket is not set on the cart 5 (NO in ACT 24), the processing shifts from ACT 24 to ACT 25.

The processing circuit 21 displays an error notification instead of the basket check notification on the display device 26, based on the determination that a shopping basket is not set on the cart 5 (ACT 25). The processing of ACT 25 may be performed by the display processing unit 213. The error notification is, for example, the basket error notification as shown in FIG. 5. The processing circuit 21 may return to the processing of ACT 24 after displaying the error notification. The processing circuit 21 may output the notification as a sound via the speaker 27 in addition to or instead of the display of the notification.

The processing circuit 21 displays the “OK” button in the basket check notification on the display device 26, based on the determination that a shopping basket is set on the cart 5 (ACT 26). The processing of ACT 26 may be performed by the display processing unit 213. Displaying the “OK” button on the display device 26 is an example of displaying the basket check notification in such a way that the user can select whether to display or hide the notification.

The processing circuit 21 determines whether the “OK” button is operated by the user or not (ACT 27). The processing of ACT 27 may be performed by the display processing unit 213. If the processing circuit 21 determines that the “OK” button is operated (YES in ACT 27), the processing shifts from ACT 27 to ACT 28. If the processing circuit 21 determines that the “OK” button is not operated (NO in ACT 27), the processing repeats ACT 27.

The processing circuit 21 determines that the merchandise registration processing can be started based on the determination by the first determination unit 214 (ACT 28). The processing of ACT 28 may be performed by the second determination unit 215. The processing circuit 21 may enable the acceptance of the merchandise registration operation by the user.

In this example, the POS terminal 2 can display the basket check notification on the display device 26 before the user registers a merchandise item. Therefore, the POS terminal 2 can prompt the user to place a basket on the cart, before starting weighing due to merchandise registration. The POS terminal 2 can also display the basket check notification in a mode in which the notification can be hidden by a user operation if the POS terminal 2 determines that a basket is placed on the cart based on the detection of a change in weight in the cart. Therefore, the POS terminal 2 can perform control in such a way that merchandise registration can be performed only when a basket is placed on the cart. Thus, the POS terminal 2 can suppress an error indication otherwise provided based on a change in weight in the cart due to the placement of a basket on the cart.

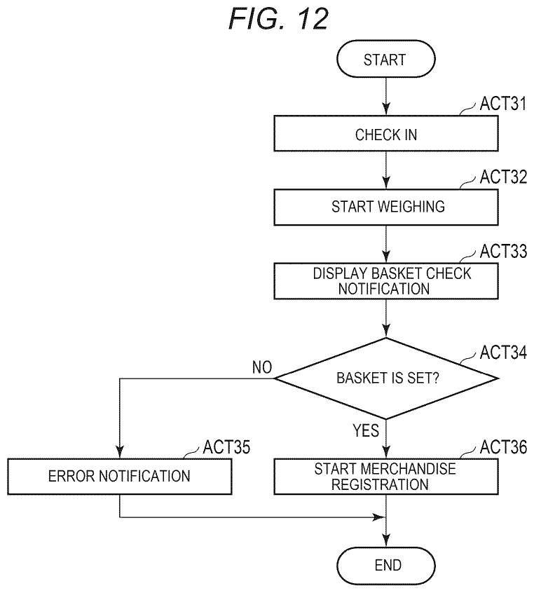

FIG. 12 is a flowchart illustrating the fourth mode of information processing by the POS terminal according to the embodiment. The fourth mode is a mode in which the weighing device 3 is made to start weighing, based on a shopping start operation by the user. The fourth mode is a mode in which the basket check notification is displayed before the user registers a merchandise item and in which merchandise registration is enabled if a basket is set on the cart 5 by the user.

The processing circuit 21 acquires a shopping start instruction, based on a shopping start operation by the user in the shopping start image displayed on the display device 26 (ACT 31), as in ACT 1.

The processing circuit 21 causes the weighing device 3 to start detecting the weight in the cart 5 (ACT 32), as in ACT 4. The weighing device 3 detects the weight in the cart 5.

The processing circuit 21 displays the basket check notification on the display device 26 (ACT 33). The processing of ACT 33 may be performed by the display processing unit 213. The processing circuit 21 displays the basket check notification after the shopping start operation by the user. In a specific example, the processing circuit 21 displays the basket check notification after the weighing device 3 starts weighing. The processing circuit 21 may output the notification as a sound via the speaker 27 in addition to or instead of the display of the notification.

The processing circuit 21 determines whether a shopping basket has been set on the cart 5 or not based on the detection of a change in weight in the cart 5 (ACT 34), as in ACT 13. The processing of ACT 34 may be performed by the first determination unit 214. If the processing circuit 21 determines that a shopping basket is set on the cart 5 (YES in ACT 34), the processing shifts from ACT 34 to ACT 36. If the processing circuit 21 determines that a shopping basket is not set on the cart 5 (NO in ACT 34), the processing shifts from ACT 34 to ACT 35.

The processing an error circuit 21 displays notification instead of the basket check notification on the display device 26, based on the determination that a shopping basket is not set on the cart 5 (ACT 35). The processing of ACT 35 may be performed by the display processing unit 213. The error notification is, for example, the basket error notification. The processing circuit 21 may return to the processing of ACT 34 after displaying the error notification. The processing circuit 21 may output the notification as a sound via the speaker 27 in addition to or instead of the display of the notification.

The processing circuit 21 determines that the merchandise registration processing can be started based on the determination by the first determination unit 214 (ACT 36). The processing of ACT 36 may be performed by the second determination unit 215. The processing circuit 21 may, for example, automatically hide the basket check notification displayed on the display device 26. The processing circuit 21 may display a merchandise registration image on the display device 26. The processing circuit 21 may enable the acceptance of the merchandise registration operation by the user.

In this example, the POS terminal 2 can display the basket check notification on the display device 26 before the user registers a merchandise item. Therefore, the POS terminal 2 can prompt the user to place a basket on the cart, before starting weighing due to merchandise registration. The POS terminal 2 can also perform control in such a way that merchandise registration can be performed if it is determined that a basket is placed on the cart based on the detection of a change in weight in the cart. Thus, the POS terminal 2 can suppress an error indication that is based on a change in weight in the cart due to the placement of a basket on the cart.

A fifth mode of information processing in the information processing system 100 after shopping is started will now be described.

The user of the POS terminal 2 puts a merchandise item into the shopping basket set on the cart 5 and registers the merchandise item put therein. If the basket equivalent weight is detected when the user is registering the merchandise item, the POS terminal 2 gives a notification to check whether a shopping basket was added to the cart 5. In the example described below, it is assumed that the user is shopping with one shopping basket set on the cart 5.

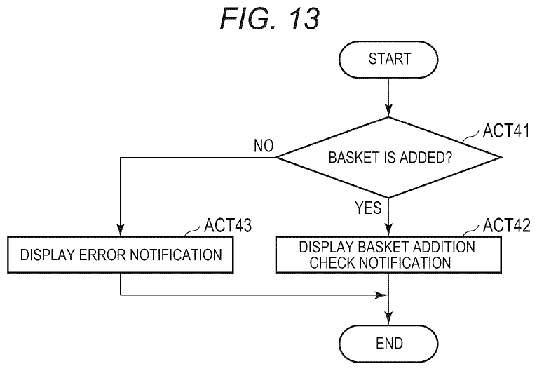

FIG. 13 is a flowchart illustrating the fifth mode of information processing by the POS terminal according to the embodiment. The fifth mode is a mode in which the basket addition check notification is displayed if a shopping basket is added to the cart 5 while the user is shopping. In the fifth mode, a case where a shopping basket is added in the state where one shopping basket is already set on the cart 5 is described. The fifth mode can also be applied to the case where the user starts shopping without setting a shopping basket on the cart 5 before merchandise registration starts.

The processing circuit 21 determines whether a shopping basket is added to the cart 5 based on the detection of a change in weight in the cart 5 (ACT 41), as in ACT 13. The processing of ACT 41 may be performed by the first determination unit 214. The processing circuit 21 determines whether the change (increase) in weight in the cart 5 is the basket equivalent weight or not. In this case, the basket equivalent weight can be the weight of one shopping basket, a weight equivalent to the weight of two shopping baskets, or a weight acquired by adding a margin of error (tolerance) to one of these weights.

A case where the weighing device 3 simultaneously detects a change in weight on the upper tier and the lower tier of the cart 5 will now be described. If the change in weight in the cart 5 is the basket equivalent weight, the processing circuit 21 determines that a basket is added. However, if a change in weight in the cart 5 corresponding to the basket equivalent weight for two baskets is detected before merchandise registration, the processing circuit 21 does not determine that a shopping basket is added to the cart 5 even though the change (increase) in weight in the cart 5 is the basket equivalent weight. In this case, the processing circuit May 21 display the failure-to-scan notification on the display device 26. After the setting of two baskets is completed, the processing circuit 21 may not determine that a basket is added even if the change (increase) in weight that is the basket equivalent weight is detected, and may determine that a merchandise item is put in the cart. In this case, the processing circuit 21 performs merchandise registration processing, as in ACT 005 and ACT 006 shown in FIG. 2.

A case where the weighing device 3 separately detects a change in weight on the upper tier and the lower tier of the cart 5 will now be described. The processing circuit 21 determines which of the upper tier and the lower tier the change in weight in the cart 5 is detected on. If the change in weight in the cart 5 is detected on the tier where the basket equivalent weight is not detected, of the upper tier and the lower tier, before merchandise registration, the processing circuit 21 determines whether the change (increase) in weight is the basket equivalent weight or not. If the change (increase) in weight is the basket equivalent weight, the processing circuit 21 determines that a basket was added. However, if a change in weight in the cart 5 corresponding to the basket equivalent weight is detected on the upper tier and the lower tier before merchandise registration, the processing circuit 21 does not determine that a shopping basket was added to the cart 5 even though the change (increase) in weight in the cart 5 is the basket equivalent weight. In this case, the processing circuit 21 may display the failure-to-scan notification on the display device 26. After the setting of a basket is completed for both the upper tier and the lower tier, the processing circuit 21 may not determine that a basket has been added even if the change (increase) in weight that is the basket equivalent weight is detected, and may instead determine that a merchandise item was put in the cart. In this case, the processing circuit 21 performs merchandise registration processing, as in ACT 005 and ACT 006 shown in FIG. 2.

If the processing circuit 21 determines that a shopping basket has been added to the cart 5 (YES in ACT 41), the processing shifts from ACT 41 to ACT 42. If the processing circuit 21 determines that a shopping basket was not added to the cart 5 (NO in ACT 41), the processing shifts from ACT 41 to ACT 43.

The processing circuit 21 displays the basket addition check notification as shown in FIG. 6 on the display device 26 based on the determination (ACT 42). The processing of ACT 42 may be performed by the display processing unit 213. The user may input information representing whether a basket was added or not based on the basket addition check notification. If the user inputs information representing that a basket is not added, the processing circuit May 21 display the failure-to-scan notification on the display device 26. The processing circuit 21 may output the notification as a sound via the speaker 27 in addition to or instead of the display of the notification.

The processing circuit 21 displays an error notification on the display device 26, based on the determination that a shopping basket is not added to the cart 5 (ACT 43). The processing of ACT 43 may be performed by the display processing unit 213. The error notification is, for example, the failure-to-scan notification. The processing circuit 21 may display the basket error notification on the display device 26.

In this example, if the POS terminal 2 determines that a basket has been placed on the cart based on the detection of a change in weight in the cart during shopping, the POS terminal 2 can display the basket addition check notification on the display device 26. The POS terminal 2 can store the expected basket weight in advance and thus can determine that a basket has been added to the cart during shopping when the detected weight change matches the stored basket weight. Therefore, if the POS terminal 2 determines that a basket has been added to the cart, the POS terminal 2 can display the basket addition check notification instead of giving an error indication such as the failure-to-scan notification. Thus, the POS terminal 2 can suppress an error indication based on a change in weight in the cart that is due to the placement of a basket on the cart.

First to fourth modes of information processing in the information processing system for the warning notification as shown in FIG. 8 will now be described.

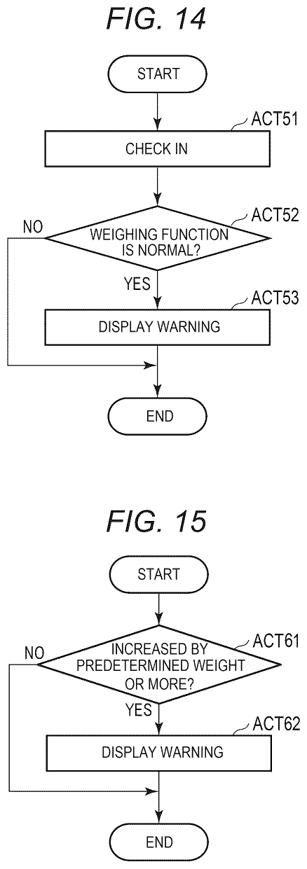

FIG. 14 is a flowchart illustrating the first mode of information processing for the warning notification by the POS terminal 2 according to the embodiment. The first mode is a mode in which the warning notification is displayed on the display device 26 before the user registers a merchandise item, based on a shopping start operation by the user.

The processing circuit 21 acquires a shopping start instruction, based on a shopping start operation by the user in the shopping start image displayed on the display device 26 (ACT 51). The processing circuit 21 may output the shopping start instruction to the cloud server 1.

The processing circuit 21 checks the weighing function of the weighing device 3 (ACT 52). The processing of ACT 52 may be performed by the setting unit 210. In ACT 52, for example, the processing circuit 21 configures an initial setting for the detection of a change in weight, based on the operation of the “OK” button by the user. The processing circuit 21 may start synchronization with the weighing device 3. The processing circuit 21 starts communication with the weighing device 3 via the communication interface 24, based on the synchronization between the POS terminal 2 and the weighing device 3. The weighing device 3 starts detecting the weight in the cart 5. The processing circuit 21 may determine whether the weighing device 3 is normally operable based on information about the motion sensor. The processing circuit 21 may determine whether the weighing device 3 is normally operable based on the battery information of the battery 33. If the processing circuit 21 determines that the weighing device 3 is normally operable (YES in ACT 52), the processing shifts from ACT 52 to ACT 53. If the processing circuit 21 determines that the weighing device 3 is not normally operable (NO in ACT 52), the processing ends. In this case, the processing circuit 21 may cause the POS terminal 2 to function as a POS terminal 2 without having a weighing function.

The processing circuit 21 displays the warning notification on the display device 26 (ACT 53). The processing of ACT 53 may be performed by the display processing unit 213. In ACT 53, the processing circuit 21 displays a notification to call the user's attention to the use of the cart 5 on the display device 26. The processing circuit 21 displays the basket check notification after the shopping start operation by the user. In a specific example, the processing circuit 21 displays the warning notification after the weighing device 3 starts weighing. The processing circuit 21 may hide the warning notification after the lapse of a predetermined time. The processing circuit 21 may hide the warning notification, based on the selection operation on the “CHECK” button by the user or the like. The processing circuit 21 may output the notification as a sound via the speaker 27 in addition to or instead of the display of the notification.

In this example, when the cart 5 can detect a weight, the POS terminal 2 can display the warning notification on the display device 26 before the user attempts to register a merchandise item. Therefore, an error indication of failure to scan or the like due to a change in weight in the cart caused by an action other than merchandise registration can be suppressed.

FIG. 15 is a flowchart illustrating the second mode of information processing for the warning notification by the POS terminal 2 according to the embodiment. The second mode is a mode in which the warning notification is displayed on the display device 26 if there is a need to call the user's attention to the use of the cart while the user is shopping. In this context, there may be a need to call the user's attention to the use of the cart if the weighing device 3 detects that some predetermined weight or more is applied in the cart 5. Here, the predetermined weight may be, for example, 1 kilogram.

The processing circuit 21 determines whether the weight in the cart 5 has increased by a predetermined weight or more based on the detection of a change in weight in the cart 5 (ACT 61). The processing of ACT 61 may be performed by the first determination unit 214. In ACT 61, the processing circuit 21 acquires the basket weight information. The processing circuit 21 determines whether the change (increase) in weight in the cart 5 is the predetermined weight or more. If the processing circuit 21 determines that the change (increase) in weight in the cart 5 is the predetermined weight or more (YES i in ACT 61), the processing shifts from ACT 61 to ACT 62. If the processing circuit 21 determines that the change (increase) in weight in the cart 5 is not the predetermined weight or more (NO in ACT 61), the processing ends.

The processing circuit 21 displays the warning notification on the display device 26 (ACT 62). The processing of ACT 62 may be performed by the display processing unit 213. In ACT 62, the processing circuit 21 displays a notification to call the user's attention to the use of the cart 5 on the display device 26. The processing circuit 21 may hide the warning notification after the lapse of a predetermined time. The processing circuit 21 may hide the warning notification, based on the selection operation on the “CHECK” button by the user, or the like. The processing circuit 21 may hide the warning notification if a change (decrease) in weight in the cart 5 is detected. The processing circuit 21 may output the notification as a sound via the speaker 27 in addition to or instead of the display of the notification.

If the weighing device 3 separately detects the change in weight on the upper tier and the lower tier of the cart 5, the processing circuit 21 in ACT 61 may determine whether the weight on the lower tier is increased by the predetermined weight or more.

In this example, the POS terminal 2 can display the warning notification on the display device 26, based on the detection of an increase in weight equal to or more than a predetermined weight in the cart 5. For example, the POS terminal 2 can display the warning notification for calling the user's attention to certain issues about the use of the cart in response to an increase in weight in the cart 5 that is considered to be due to an action such as putting a foot on the cart, an action of getting on the cart, or the like. Thus, if an increase in weight equal to or more than this predetermined weight is detected, the POS terminal 2 can suppress an error indication of failure to scan or the like due to a change in weight in the cart that might otherwise be caused by a user action other than merchandise registration or putting an item in the cart 5. The POS terminal 2 can also give a notification corresponding to the detection of weight. Moreover, the POS terminal 2 can prompt the user to use the cart correctly.

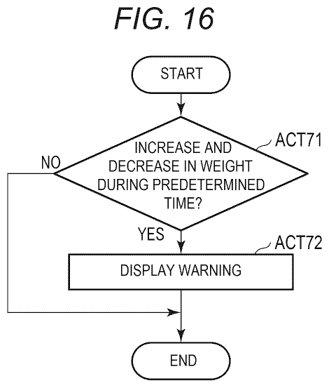

FIG. 16 is a flowchart illustrating the third mode of information processing for the warning notification by the POS terminal 2 according to the embodiment. The third mode is a mode in which the warning notification is displayed on the display device 26 if there is a need to call the user's attention to the (appropriate) use of the cart while the user is shopping. In the third mode, that there is a need to call the user's attention to the use of the cart when the weighing device 3 repeatedly detects an increase and a decrease in weight equal to or more than some predetermined weight in the cart 5. For example, when an action of repeatedly putting a foot on and off the cart 5 is performed, it is expected that an increase and a decrease in weight equal to or more than the predetermined weight will be detected in the cart 5. The predetermined weight is, for example, 1 kilogram in this context.

The processing circuit 21 determines whether the weight in the cart 5 is increased and decreased by a predetermined weight or more during a predetermined time based on the detection of a change in weight in the cart 5 (ACT 71). The processing of ACT 71 may be performed by the first determination unit 214. The predetermined time is, for example, 1 minute or 5 minutes or the like. In ACT 71, for example, the processing circuit 21 acquires the basket weight information. The processing circuit 21 determines whether the change (increase and decrease) in weight in the cart 5 is repeated during the predetermined time. If the processing circuit 21 determines that the change (increase and decrease) in weight in the cart 5 is repeated during the predetermined time (YES in ACT 71), the processing shifts from ACT 71 to ACT 72. If the processing circuit 21 determines that the change (increase and decrease) in weight in the cart 5 is not repeated during the predetermined time (NO in ACT 71), the processing ends. In this context the change (increase and decrease) in weight in the cart 5 may be considered to be repeated during the predetermined time when the weight in the cart 5 is increased and subsequently decreased during the predetermined time. The change (increase and decrease) in weight in the cart 5 can be considered to be repeated during the predetermined time when an increase and subsequent decrease in weight in the cart 5 is repeated during the predetermined time. The processing circuit 21 may determine whether an increase and decrease in weight in the cart 5 equal to or more than a predetermined weight is repeated during the predetermined time or longer.

The processing circuit 21 displays the warning notification on the display device 26 (ACT 72). The processing of ACT 72 may be performed by the display processing unit 213. In ACT 72, the processing circuit 21 displays a notification to call the user's attention to the use of the cart 5 on the display device 26. The processing circuit 21 may hide the warning notification after the lapse of a predetermined time. The processing circuit 21 may hide the warning notification, based on the selection operation on the “CHECK” button by the user or the like. The processing circuit 21 may hide the warning notification when a change (decrease) in weight in the cart 5 is detected. The processing circuit 21 may output the notification as a sound via the speaker 27 in addition to or instead of the display of the notification.

If the weighing device 3 separately detects the change in weight on the upper tier and the lower tier of the cart 5, the processing circuit 21 in ACT 71 may determine whether the weight on the lower tier is increased and decreased by the predetermined weight or more.

In this example, the POS terminal 2 can display the warning notification on the display device 26, based on the detection of an increase and decrease in weight equal to or more than a predetermined weight in the cart 5 during a predetermined time. For example, the POS terminal 2 can display the warning notification for calling the user's attention to the issues about the use of the cart in response to an increase and decrease in weight in the cart 5 that is considered to be due to an action of putting a foot on and off the cart, an action of getting on and off the cart, or the like. Thus, if an increase and decrease in weight equal to or more than the predetermined weight is detected during the predetermined time, the POS terminal 2 can suppress an error indication of failure to scan or the like that might otherwise be triggered due to a change in weight in the cart caused by an action by the user other than merchandise registration. The POS terminal 2 can also give a notification corresponding to the detection of weight. Moreover, the POS terminal 2 can prompt the user to use the cart correctly.

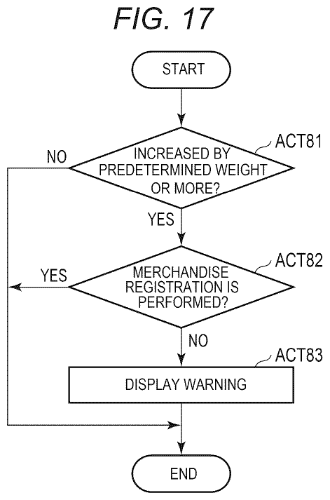

FIG. 17 is a flowchart illustrating the fourth mode of information processing for the warning notification by the POS terminal 2 according to the embodiment. The fourth mode is a mode in which the warning notification is displayed on the display device 26 if there is a need to call the user's attention to the use of the cart while the user is shopping. There may be a need to call the user's attention to certain issues about the use of the cart when, for example, the weighing device 3 detects that some predetermined weight or more has been applied in the cart 5. This predetermined weight can be, for example, 1 kilogram.

The processing circuit 21 determines whether the weight in the cart 5 is increased by a predetermined weight or more based on the detection of a change in weight in the cart 5 (ACT 81), as in ACT 61. The processing of ACT 81 may be performed by the first determination unit 214. If the processing circuit 21 determines that the change (increase) in weight in the cart 5 is the predetermined weight or more (YES in ACT 81), the processing shifts from ACT 81 to ACT 82. If the processing circuit 21 determines that the change (increase) in weight in the cart 5 is not the predetermined weight or more (NO in ACT 81), the processing ends.

The processing circuit 21 determines whether the plus operation is performed by the user within a predetermined period by reference to the user operation history (ACT 82). The processing of ACT 82 may be performed by the first determination unit 214. The predetermined period is, for example, a period of 10 seconds after the time point at which the result of a detection of a change in weight in the cart 5 is acquired. If the processing circuit 21 determines that the plus operation is performed within the predetermined period (YES in ACT 82), the processing ends. If the processing circuit 21 determines that the plus operation is not performed within the predetermined period in connection with the change (increase) in weight in the cart 5 (NO in ACT 82), the processing shifts from ACT 82 to ACT 83.

The processing circuit 21 displays the warning notification on the display device 26 (ACT 83). The processing of ACT 83 may be performed by the display processing unit 213. In ACT 83, the processing circuit 21 displays a notification to call the user's attention to the use of the cart 5 on the display device 26. The processing circuit 21 may hide the warning notification after the lapse of a predetermined time. The processing circuit 21 may hide the warning notification, based on the selection operation on the “CHECK” button by the user, or the like. The processing circuit 21 may hide the warning notification if a change (decrease) in weight in the cart 5 is detected. The processing circuit 21 may output the notification as a sound via the speaker 27 in addition to or instead of the display of the notification.

The processing circuit 21 in ACT 81 may determine whether the weight in the cart 5 is increased and decreased by a predetermined weight or more during a predetermined period based on the detection of a change in weight in the cart 5.

If the weighing device 3 separately detects the change in weight on the upper tier and the lower tier of the cart 5, the processing circuit 21 in ACT 81 may determine whether the weight on the lower tier is increased by the predetermined weight or more. If the processing circuit 21 determines that the change (increase and decrease) in weight in the cart 5 is repeated during the predetermined time (YES in ACT 81), the processing shifts from ACT 81 to ACT 82. If the processing circuit 21 determines that the change (increase and decrease) in weight in the cart 5 is not repeated during the predetermined period (NO in ACT 81), the processing ends.

In this example, the POS terminal 2 can display the warning notification on the display device 26 when an increase in weight equal to or more than a predetermined weight is detected in the cart 5 and a merchandise registration operation was not performed by the user. For example, the POS terminal 2 does not display the warning notification for calling the user's attention to issues about the use of the cart if a merchandise item of the predetermined weight or more is placed on the cart. Therefore, the POS terminal 2 can suppress an error indication of failure to scan or the like due to a change in weight in the cart caused by an action other than merchandise registration. The POS terminal 2 can also prompt the user to use the cart correctly. Moreover, the POS terminal 2 can give a notification corresponding to the detection of weight.

### Other Embodiments

The information processing terminal may be implemented as one electronic device, such as a POS terminal 2, or as a plurality of electronic devices with distributed functions working in conjunction.

An embodiment may also be applied as a method executed by a device or a software program or the like that can cause a device to execute each of the appropriate function, such a software program may be embodied in a recording medium storing the program.

The circuit or circuits forming the processing circuit executes one or more processes of a plurality of processes. If the processing circuit is formed as a single circuit, the single circuit executes all of the plurality of processes. If the processing circuit is formed by a plurality of circuits, each of the plurality of circuits may execute a part of the plurality of processes. If the processing circuit is formed by a plurality of circuits, the plurality of circuits may be included in one device or may be distributed among a plurality of devices.

The program may be stored in a device according to an embodiment or may be provided separately from a device. In the latter case, the program may be provided via a network or in a recording medium. The recording medium can be a non-transient tangible medium that is a computer-readable medium. In general, the recording medium may be any medium that can store the program and can be read by a computer, such as a CD-ROM or a memory card, but is not limited to any particular form or format.

While some embodiments of the present disclosure have been described, these embodiments are presented simply as examples and are not intended to limit the scope of the present disclosure. These novel embodiments can be implemented in various other forms and can include various omissions, replacements, and changes without departing from the spirit and scope of the present disclosure. These embodiments and modifications thereof are included in the spirit and scope of the present disclosure and also included in the scope of the claims and equivalents thereof.

What is claimed is:

1. A cart-based point-of-sale terminal, comprising:
a display device mounted on a shopping cart; and
a control unit configured to:
register items of merchandise for purchase in a sales transaction, and
cause the display device to display a shopping basket notification to a user before a user can register an item of merchandise.

2. The cart-based point-of-sale terminal according to claim 1, wherein the control unit is further configured to:
receive weight detection output from a weight sensor on the shopping cart, and
determine whether a shopping basket has been placed on the shopping cart based on the weight detection output from the weight sensor.

3. The cart-based point-of-sale terminal according to claim 2, wherein the control unit is further configured to:
cause the display device to end display of the shopping basket notification when it is determined the shopping basket has been placed on the shopping cart.

4. The cart-based point-of-sale terminal according to claim 2, wherein the control unit is further configured to:
cause the display device to start display of the shopping basket notification when it is determined that the shopping basket has been placed on the shopping cart.

5. The cart-based point-of-sale terminal according to claim 1, wherein the control unit is further configured to:
receive weight detection output from a weight sensor on the shopping cart, wherein
the display device is caused to display the shopping basket notification to the user when the weight detection output is received before a start of merchandise registration and the weight detection output corresponds to an expected weight change of an empty shopping basket.

6. The cart-based point-of-sale terminal according to claim 1, wherein the control unit is further configured to:
receive weight detection output from a weight sensor on the shopping cart, and
cause the display device to display a warning notification different from the shopping basket notification when the weight detection output indicates a weight greater than an expected weight change of an empty shopping basket has been placed on the shopping cart.

7. The cart-based point-of-sale terminal according to claim 1, wherein the control unit is further configured to:
receive weight detection output from a weight sensor on the shopping cart, and
cause the display device to display a warning notification different from the shopping basket notification when the weight detection output indicates repeated changes in weight during a fixed period of time.

8. The cart-based point-of-sale terminal according to claim 1, further comprising:
a weight sensor on the shopping cart, wherein
the control unit is further configured to:
receive weight detection output from the weight sensor.

9. A cart-based point-of-sale system, comprising:
a cart;
a weighing device on the cart;
a product scanner on the cart;
a display device on the cart; and
a point-of-sale terminal on the cart and including a control unit configured to:
register items of merchandise for purchase in a sales transaction based on input from the product scanner, and
cause the display device to display a shopping basket notification to a user before a user can register an item of merchandise.

10. The cart-based point-of-sale system according to claim 9, wherein the control unit is further configured to:
receive weight detection output from the weighing device, and
determine whether a shopping basket has been placed on the cart based on the weight detection output from the weighing device.

11. The cart-based point-of-sale system according to claim 10, wherein the control unit is further configured to:
cause the display device to end display of the shopping basket notification when it is determined the shopping basket has been placed on the cart.

12. The cart-based point-of-sale system according to claim 10, wherein the control unit is further configured to:
cause the display device to start display of the shopping basket notification when it is determined that the shopping basket has been placed on the cart.

13. The cart-based point-of-sale system according to claim 9, wherein the control unit is further configured to:
receive weight detection output from the weighing device, wherein
the display device is caused to display the shopping basket notification to the user when the weight detection output is received before a start of merchandise registration and the weight detection output corresponds to an expected weight change of an empty shopping basket.

14. The cart-based point-of-sale system according to claim 9, wherein the control unit is further configured to:
receive weight detection output from the weighing device, and
cause the display device to display a warning notification different from the shopping basket notification when the weight detection output indicates a weight greater than an expected weight change of an empty shopping basket has been placed on the cart.

15. The cart-based point-of-sale system according to claim 9, wherein the control unit is further configured to:
receive weight detection output from the weighing device, and
cause the display device to display a warning notification different from the shopping basket notification when the weight detection output indicates repeated changes in weight during a fixed period of time.

16. The cart-based point-of-sale system according to claim 9, wherein
the point-of-sale terminal further includes:
a communication interface connected to a server device, and
the control unit registers items of merchandise for purchase in the sales transaction by sending merchandise codes to the server device.

17. A method for a cart-based point-of-sale terminal, the method comprising:
causing a display device mounted on a shopping cart to display a shopping basket notification to a user before a user can register items of merchandise for purchase in a sales transaction; and
registering an item of merchandise for purchase in the sales transaction after the shopping basket notification is cleared from the display device.

18. The method according to claim 17, further comprising:
determining whether a shopping basket has been placed on the shopping cart based on a weight detection output from a weight sensor mounted on the cart.

19. The method according to claim 18, further comprising:
causing the display device to clear the display of the shopping basket notification when it is determined the shopping basket has been placed on the shopping cart.

20. The method according to claim 17, further comprising:
receiving weight detection output from a weight sensor on the shopping cart; and
causing the display device to display the shopping basket notification to the user when the weight detection output is received before a start of merchandise registration.
